(19) United States
(12) Patent Application Publication
(10) Pub. No.: US 2023/0150187 A1
(43) Pub. Date: May 18, 2023

(54) FILAMENT FOR ADDITIVE MANUFACTURING AND PROCESS FOR MAKING THE SAME

(71) Applicant: VICTREX MANUFACTURING LIMITED, Thornton Cleveleys, Lancashire (GB)

(72) Inventors: Adam Chaplin, Thornton Cleveleys, Lancashire (GB); Connor Dallas, Thornton Cleveleys, Lancashire (GB); Charlotte Ridout, Thornton Cleveleys, Lancashire (GB); Martin Riley, Thornton Cleveleys, Lancashire (GB); Adrian Thorpe, Thornton Cleveleys, Lancashire (GB)

(21) Appl. No.: 17/906,594

(22) PCT Filed: Apr. 6, 2021
(86) PCT No.: PCT/GB2021/050843

§ 371 Date: Sep. 16, 2022

(30) Foreign Application Priority Data
Apr. 7, 2020 (GB) 2005092.8

(51) Int. Cl. B29C 64/118; B33Y 10/00; B33Y 70/00; B29C 64/314

(52) U.S. Cl. CPC B29C 64/118; B33Y 10/00; B33Y 70/00; B29C 64/314; B29K 2071/00

(57) ABSTRACT

A fused filament fabrication filament, method and process, for layer-wise formation of a component, wherein the filament, method and process comprise feedstock material comprising a polyaryletherketone, PAEK and optionally, one or more filler means.

The invention relates to fused filament fabrication filament, for use in layer-wise formation of a component by additive manufacturing. The invention also extends to a process for making filament and a process for improving mechanical properties of components made by additive manufacturing processes.

Methods in which rapid manufacturing of components is carried out from construction data under computer control are sometimes referred to as rapid prototyping methods. A well-known approach named Additive Manufacturing (AM) concerns the step-wise (often layer-wise) construction of a component from a shapeless material or a material that is neutral with respect to shape. Typically, a three-dimensional model of a component to be fabricated is provided to an apparatus (e.g. a 3D printer), which then autonomously fabricates the component by gradually depositing, or otherwise forming, the constituent material in the shape of the component to be fabricated. Successive parts (e.g., layers) of material that represent cross-sections of the component may be deposited or otherwise formed; generally, the deposited parts/layers of material fuse (or otherwise solidify) to form the final component.

Originally, additive layer manufacturing methods were limited to prototyping, but now the methods are used for component manufacture. In this specification, such methods will be referred to by the term additive layer manufacturing (ALM), indicating that 3D parts are constructed by the build-up of successive layers. This may be contrasted with traditional manufacturing by machining, in which material is removed or “subtracted” from a starting blank in order to arrive at a desired component shape.

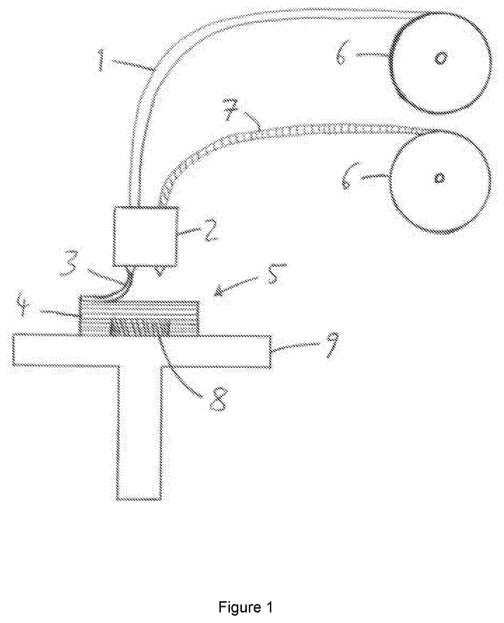

One such technique is Fused Deposition Modelling™ (FDM), also known as fused filament fabrication (FFF), as shown in FIG. 1, in which generally a feedstock material 1 is fed into a heated print-head 2, which may be movable in a number of different directions, and then extruded in molten form 3 to print a part (e.g., a layer) of build material 4. The stepwise addition of further layers can occur continuously until the desired three-dimensional component 5 has been created. The feedstock material 2 may be in the form of a filament on a reel 6 and in some cases two or more different filaments may be simultaneously melted and then printed selectively. For instance, one of the filaments may comprise a support material 7 which is needed only at locations above which an overhanging part of the three-dimensional component 5 is printed and requires support during the subsequent printing procedure. The extruded support material 8 can be removed subsequently, e.g. via dissolution in acids, bases or water and other solvents. Support structures such as breakaway supports are also used whereby the support structure is mechanically removed post printing. The build material 4 forms the actual three-dimensional component 5. The extrusion is carried out on a build platform 9 which may be movable in several different directions. There are a number of processes related to FDM that employ slight modifications, for example melt extrusion manufacturing (MEM) or selective deposition modelling (SDM). In other examples, feedstock material may be supplied as short filaments, rods, micropellets or granules. The feedstock is then placed in a feedstock hopper and fed through an extruder to a nozzle or printhead and printed as described above.

Whilst FFF is advantageous in terms of its economic use of materials, it would be beneficial to provide process improvements such as better adhesion between adjacent layers of extruded material. In order to build up a three-dimensional component with good mechanical strength, it is necessary to adequately fuse together successive layers/parts of material. However, poor adhesion between adjacent layers can result, in particular in the “z” or vertical direction (i.e. where an upper layer is extruded on top of a lower layer) because the lower layer has had longer to cool down (and therefore harden) when compared with adhesion of the lower layer to adjacent layers in the horizontal (“x” and “y”) directions. This is particularly problematic for FFF processes because it takes some time for a print head to complete depositing a layer of material such that there may be considerable time between sequential layers of material. The preceding layer may have cooled down such that the preceding layer has crystallised making fusion between the preceding layer and the subsequent layer difficult. With semi-crystalline polymers, the rate of solidification is far quicker than with amorphous polymers because semi-crystalline polymers can crystallise rapidly therefore the preceding layer may solidify far quicker than a layer of amorphous polymer. Crystallisation therefore locks in the shape of the polymer.

A wide range of different types of polymeric materials has been proposed for use as building materials in ALM. Poly(aryletherketone) polymers, referred to herein as PAEK polymers, have been found to be particularly useful, as components that have been manufactured from PAEK powder or PAEK granulates are typically characterised by a low flammability, good biocompatibility as well as a high resistance against hydrolysis and radiation. It is the thermal resistance also at elevated temperatures as well as the chemical resistance that distinguishes PAEK powders from conventional polymer powders such as polyamides, polyesters and the like. The high-performance characteristics of PAEK polymers, combined with their low density, make them of use in the aerospace industry, in the automotive industry, in the electronic industry and in the medical industry.

US2015251353 is one such example of a method for printing a three-dimensional part with an additive manufacturing system, which includes providing a consumable feedstock material comprising a semi-crystalline polymer containing one or more secondary materials, wherein the consumable feedstock material has a process window in which crystalline kinetics are either accelerated or retarded. The consumable feedstock material is melted in the additive manufacturing system. At least a portion of the three-dimensional part from the melted consumable feedstock material in a build environment is maintained within the process window. Controlling crystallisation kinetics through the printing method is one way to improve mechanical properties of the printed part, however this is not the preferred approach as this approach could compromise the properties of the part and could impact the high temperature performance and solvent resistance of the materials. Instead, further improvement in crystallisation kinetics of materials is required to improve mechanical properties of printed parts so that FFF may be more readily adopted for manufacturing components beyond prototyping.

It is an object of the invention to address one or more of the above-described problems.

According to a first aspect, there is provided a fused filament fabrication filament, for use in layer-wise formation of a component, wherein the filament comprises feedstock material comprising a polyaryletherketone, PAEK and one or more filler means, wherein the PAEK is a copolymer comprising repeat units of formula

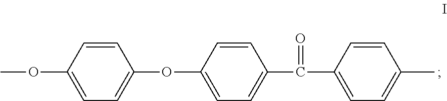

and

repeat units of formula

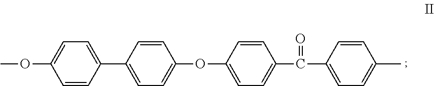

wherein at least 95 mol % of the copolymer repeat units are repeat units of formula I and of formula II;

wherein the repeat units I and II have a molar ratio 1:11 from 60:40 to 80:20; and

wherein the PAEK has a shear viscosity, SV, from 100 to 400 Pa·s as measured using capillary rheometry at operating at 400° C. at a shear rate of 1000 s⁻¹ using a circular cross-section tungsten carbide die, 0.5 mm (capillary diameter)×8 mm (capillary length), and

wherein the one of more fillers comprises at least 5 wt % and up to 38 wt % of the composition.

It has been surprisingly found that a filament according to the present invention provides a high level of interlayer adhesion and therefore improved z-direction strength because the feedstock material is adapted to control the crystallisation properties of the filament throughout the printing process.

The feedstock may comprise at least 62 wt. % to 95 wt. % copolymer.

Preferably, the SV of the copolymer is from 150 to 300 Pa·s, and more preferably, 180 to 260 Pa·s.

In an embodiment, the molar ratio 1:11 of the copolymer is from 72:28 to 78:22.

It has been surprisingly found that filament made from feedstock comprising copolymer having a monomer ratio from 72:28 to 78:22 is particularly good for use in FFF apparatus having heated chambers such that the temperature of the printed component is controllable during the printing process. This is particularly useful for printing small components since it is easier to control the chamber temperature of a small chamber.

In another embodiment, the molar ratio 1:11 of the copolymer is from 62:38 to 68:32.

It has been surprisingly found that filament made from feedstock comprising copolymer having a monomer ratio from 62:38 to 68:32 is particularly good for use in FFF apparatus having ambient chambers. This is particularly useful for printing large components since it is not possible to control the temperature of a large build chamber.

The feedstock material is a compound comprising polymeric material and at least one filler.

It has been found that the properties of the filament may be adapted to provide certain advantageous material characteristics in a component. The incorporation of fillers is beneficial because it can reduce the level of shrinkage on solidification of the extruded feedstock material present in the manufactured object. There are many other benefits of incorporating fillers into the feedstock materials including imparting new and desirable mechanical, electrical, tribological, aesthetic, manufacturability, chemical adhesion, hydrophobicity/hydrophilicity, density, identification, and thermal properties to the printed components. In certain examples, air/water tightness may be improved in printed components.

Optionally, the one of more fillers may selected from a fibrous filler and a non-fibrous filler.

Preferably, the fibrous filler is a continuous fibrous filler or a discontinuous fibrous filler.

Preferably, the melting temperature for the fibrous filler should be at least 450° C.

Preferably, the filler wt. % for fibrous fillers is from 7 wt. % to 25 wt. %, and even more preferably, at least 10 wt. % and not more than 20 wt. %.

Optionally, one or more fillers may be selected from glass fibre, carbon fibre, asbestos fibre, silica fibre, para-aramid fibre, Kevlar fibre, ceramic fibre, alumina fibre, zirconia fibre, boron nitride fibre, silicon nitride fibre, boron fibre, fluorocarbon resin fibre and potassium titanate fibre, mica, silica, talc, HydroxyApatite (or Hydroxyl Apatite), alumina, kaolin, calcium sulfate, calcium carbonate, titanium oxide, titanium dioxide, zinc sulphide, ferrite, clay, glass powder, zinc oxide, nickel carbonate, iron oxide, quartz powder, magnesium carbonate, fluorocarbon resin, graphite, graphene, carbon powder, nanotubes, nanofibres and/or barium sulphate.

In one example, the filler may be high performance polymer fibre such as a polyaryletherketone fibre, or a polyetheretherketone fibre. In such an example, the high-performance polymer may be selected to have a melting temperature greater than the melting temperature of the copolymer. In another example, the filler may be a liquid crystalline polymer fibre.

Preferably, the one of more fillers is discontinuous carbon fibre having a nominal length between 100 microns and 800 microns, or more preferably 100 to 300 microns.

Additional particles or additives may be included in the feedstock material including ingredients such as:
other polymer particles, for instance particles of other high-performance polymers such as PAEK polymers,
filler particles,
flow aid particles,
radiation absorbers, adhesion promoters, impact modifiers, conductivity modifiers, and rheology modifiers,
density modifiers (e.g. hollow spheres, heavy metals),
thermal and electrical conductivity modifiers, and—tribological modifiers.

Mixtures of fillers may be employed. Some fillers may also act as radiation absorbers and/or as flow-aids.

Suitable radiation absorbers include carbon black, copper hydroxide phosphate (CHP), chalk, animal charcoal, carbon fiber, graphite, flame retardant, talc, silica, interference pigments and mixtures thereof. Suitable radiation absorbers may be particles having a median diameter of 1 μm or less such that they tend to coat the other particles of the copolymer.

Suitable tribological modifiers include carbon fiber and PTFE.

Suitable conductivity modifiers include carbon fiber and boron nitride.

The feedstock material may further include a viscosity modifier such as ethylene-octene copolymer such as Paraloid 3815, buytyl acrylate/PMMA core-shell such as Paraloid 3361, silicone such as Kaneka Kane-Ace MR02, or polyoctohedralsilsesquioxane compounds.

Optionally, wherein the ratio of the copolymer shear viscosity measured at a shear rate of 100 s¹ to the copolymer shear viscosity measured at a shear rate of 10,000 s⁻¹ is from 2.0 to 6.0, with the shear viscosity at each shear rate measured using capillary rheometry operating at 400° C. using a circular cross-section tungsten carbide die, 0.5 mm (capillary diameter)×3.175 mm (capillary length), and more preferably, the ratio of the copolymer shear viscosity measured at a shear rate of 100 s⁻¹ to the copolymer shear viscosity measured at a shear rate of 10,000 s⁻¹ is from 3.0 to 5.5, or even more preferably, 3.5 to 5.0, with the shear viscosity at each shear rate measured using measured using capillary rheometry operating at 400° C. using a circular cross-section tungsten carbide die, 0.5 mm (capillary diameter)×8.0 mm (capillary length), where the shear rate is increased from 100 s⁻¹ to 10,000 s⁻¹.

Optionally, the filament may comprise a core and a shell wherein the core consists of copolymer and the shell comprises copolymer and filler means. The shell may include fillers such as graphite or carbon nanoparticles. In another embodiment, the arrangement described may be adapted, with copolymer and fillers substantially forming the core, or copolymer and fillers in both the core and shell with different filler compositions in each.

A benefit of a functionalised shell and/or core is that the filament may be adapted by external energy sources during printing. The fillers in the shell or core may be selected to impart thermal or mechanical properties to the shell or core during the printing process. Another benefit of a functionalised core is that the bulk properties of the filament, such as density, may be modified without affecting interlayer adhesion of the unmodified shell during the printing process.

In an example, the filament may have a circular cross-section. The filament may have a non-circular cross-section.

The filament may have other cross-sectional shapes including oval, square or rectangular, multi-facetted (e.g., hexagon, octagon), or non-uniform cross sections.

The filament may have a cross-sectional diameter from 0.5 mm to 5 mm. More preferably, the filament may have a cross-sectional diameter from 1 mm to 3 mm. Even more preferably, the filament may have a cross-sectional diameter of 1.75 mm or 2 mm, or 2.5 mm, 2.85 mm or 3 mm. The most preferred ross-sectional diameter of the filament is 1.75 mm.

In a second aspect to the invention, there is provided the use of a filament according to the first aspect, in a process for formation of a component in a layer-wise fashion by sequentially depositing layers of the feedstock material in layers, each layer defining a cross-section of the component.

It has been surprisingly found that such components exhibit superior mechanical properties especially in the direction normal to the plane of a build platform (z-direction).

In a third aspect of the invention, there is provided a method for manufacturing a component, the method comprising:

(i) selecting a filament, according to the first aspect; and

(ii) forming the component in a layer-wise fashion by feeding the filament through an extruder nozzle and sequentially depositing layers of feedstock material such that a plurality of layers correspond to respective cross-sections of the component;

wherein a first layer of feedstock material forms a base layer of the component; and

each subsequently deposited layer of feedstock material forms a subsequent layer of the component and bonds to the respective preceding layer of the component on contact with the preceding layer whereby the component is formed from the mutually bonded portions of the plurality of layers corresponding to respective cross-sections of the component.

Preferably the method for manufacturing a component is a fused filament fabrication process.

Preferably, in step ii), the filament is fed into a printing head and the subsequent extrusion of the feedstock material in step ii) occurs in said printing head.

In some embodiments, in step ii), the feedstock material is fed into a nozzle of a printing head and the subsequent extrusion of the feedstock material in step ii) occurs in said nozzle. Preferably the feedstock material is extruded from a printing head, more preferably a nozzle of a printing head. The feedstock material may be fed into more than one printing head. Preferably the feedstock material is heated prior to entering the printing head. Step ii) may comprise extrusion from more than one printing head.

An apparatus for performing the fused filament fabrication may comprise a control unit configured for controlling said apparatus. Said control unit may be configured to control said apparatus such that said apparatus is capable of extruding material in accordance with a predetermined digital representation of the component.

In step ii) the feedstock material may preferably be heated to at least 280° C., more preferably at least 290° C., even more preferably at least 295° C., most preferably at least 300° C., but preferably at most 500° C., more preferably 450° C., or more preferably at most 500° C., most preferably at around 400° C., 370° C. or 360° C. or even more preferably at most 350° C. In step ii) the feedstock material may preferably be heated for a duration of at least 1 second, more preferably at least 5 seconds, even more preferably at least 10 seconds, even more preferably at least 20 seconds, most preferably at least 30 seconds, but preferably at most 5 min, more preferably at most 3 min, even more preferably at most 2 min, most preferably at most 1 min.

Preferably the feedstock material is in the form of a filament prior to extruding in step ii). Prior to extruding in step ii) said filament may be provided by a supply means to an apparatus for performing the method for manufacturing a component.

Said filament may be provided on a rotatable spool. Said rotatable spool may form part of a cassette. Said cassette may be arranged to be inserted into an apparatus for performing the process of the first aspect.

Preferably the plurality of parts comprises a plurality of layers that define the component.

In some preferred embodiments wherein the feedstock material and/or second material are in the form of a filament prior to shearing in step ii), the filament of the feedstock material and/or the filament of the second material may have been obtained by quenching a molten form of said filament of the feedstock material and/or said filament of the second material. In the context of this embodiment the term “quenching” means cooling the molten filament at an enhanced rate in comparison with the cooling that would occur under ambient conditions, e.g. the molten filament may be cooled to a solid form in less than 5 min, preferably less than 2 min, more preferably less than 1 min, even more preferably less than 30 seconds, most preferably less than 10 seconds. The quenching may occur using a medium comprising one or more of water, brine, caustic soda, aqueous polymers, oils, molten salts, air, nitrogen, argon, and/or helium. Quenching can reduce crystallinity which can increase the hardness of the filament, and may widen the temperature window in which the filament can then subsequently be processed.

In a fourth aspect of the invention, there is provided a process for improving the printability of a fused filament fabrication filament, the process comprising:
extruding feedstock material through a die to form a filament wherein the feedstock material comprises a polyaryletherketone, PAEK and optionally, one or more filler means;
annealing the filament at a temperature between glass transition temperature Tg and the melt temperature Tm, for a period of time sufficient to increase the temperature of the filament to above the glass transition temperature of the feedstock material.

Optionally, the feedstock material comprises:

a copolymer comprising repeat units of formula

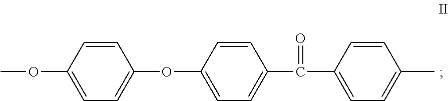

and

repeat units of formula

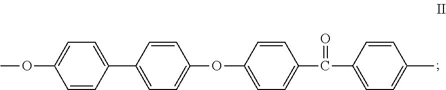

wherein at least 95 mol % of the copolymer repeat units are repeat units of formula I and of formula II;

wherein the repeat units I and II have a molar ratio 1:11 from 60:40 to 80:20; and

wherein the PAEK has a shear viscosity, SV, from 100 to 400 Pa·s as measured using capillary rheometry at operating at 400° C. at a shear rate of 1000 s⁻¹ using a circular cross-section tungsten carbide die, 0.5 mm (capillary diameter)×8 mm (capillary length); and

optionally, wherein the one of more fillers comprises at least 5 wt. % and up to 38 wt. % of the composition.

The feedstock may comprise at least 62 wt. % to 95 wt. % copolymer.

Preferably, the SV of the copolymer is from 150 to 300 Pa·s, and more preferably, 180 to 260 Pa·s.

In an embodiment, the molar ratio 1:11 of the copolymer is from 72:28 to 78:22.

It has been surprisingly found that filament made from feedstock comprising copolymer having a monomer ratio from 72:28 to 78:22 is particularly good for use in FFF apparatus having heated chambers such that the temperature of the printed component is controllable during the printing process. This is particularly useful for printing small components since it is easier to control the chamber temperature of a small chamber.

In another embodiment, the molar ratio 1:11 of the copolymer is from 62:38 to 68:32.

It has been surprisingly found that filament made from feedstock comprising copolymer having a monomer ratio from 62:38 to 68:32 is particularly good for use in FFF apparatus having ambient chambers. This is particularly useful for printing large components since it is not possible to control the temperature of a large build chamber.

The feedstock material is a compound comprising polymeric material and at least one filler.

It has been found that the properties of the filament may be adapted to provide certain advantageous material characteristics in a component. The incorporation of fillers is beneficial because it can reduce the level of shrinkage on solidification of the extruded feedstock material present in the manufactured object. There are many other benefits of incorporating fillers into the feedstock materials including imparting new and desirable mechanical, electrical, tribological, aesthetic, manufacturability, chemical adhesion, hydrophobicity/hydrophilicity, density, identification, and thermal properties to the printed components. In certain examples, air/water tightness may be improved in printed components.

Optionally, the one of more fillers may selected from a fibrous filler and a non-fibrous filler.

Preferably, the fibrous filler is a continuous fibrous filler or a discontinuous fibrous filler. Preferably, the melting temperature for the fibrous filler should be at least 450° C.

Preferably, the filler wt. % for fibrous fillers is from 7 wt. % to 25 wt. %, and even more preferably, at least 10 wt. % and not more than 20 wt. %.

Optionally, one or more fillers may be selected from glass fibre, carbon fibre, asbestos fibre, silica fibre, para-aramid fibre, Kevlar fibre, ceramic fibre, alumina fibre, zirconia fibre, boron nitride fibre, silicon nitride fibre, boron fibre, fluorocarbon resin fibre and potassium titanate fibre, mica, silica, talc, HydroxyApatite (or Hydroxyl Apatite), alumina, kaolin, calcium sulfate, calcium carbonate, titanium oxide, titanium dioxide, zinc sulphide, ferrite, clay, glass powder, zinc oxide, nickel carbonate, iron oxide, quartz powder, magnesium carbonate, fluorocarbon resin, graphite, graphene, carbon powder, nanotubes, nanofibres and/or barium sulphate.

In one example, the filler may be high performance polymer fibre such as a polyaryletherketone fibre, or a polyetheretherketone fibre. In such an example, the high-performance polymer may be selected to have a melting temperature greater than the melting temperature of the copolymer. In another example, the filler may be a liquid crystalline polymer fibre.

Preferably, the one of more fillers is discontinuous carbon fibre having a nominal length between 100 microns and 800 microns, or more preferably 100 to 300 microns.

Additional particles or additives may be included in the feedstock material including ingredients such as:
other polymer particles, for instance particles of other high-performance polymers such as PAEK polymers,
filler particles,
flow aid particles,
radiation absorbers, adhesion promoters, impact modifiers, conductivity modifiers, and rheology modifiers,
density modifiers (e.g. hollow spheres, heavy metals),
thermal and electrical conductivity modifiers, and—tribological modifiers.

Mixtures of fillers may be employed. Some fillers may also act as radiation absorbers and/or as flow-aids.

Suitable radiation absorbers include carbon black, copper hydroxide phosphate (CHP), chalk, animal charcoal, carbon fiber, graphite, flame retardant, talc, silica, interference pigments and mixtures thereof. Suitable radiation absorbers may be particles having a median diameter of 1 μm or less such that they tend to coat the other particles of the copolymer.

Suitable tribological modifiers include carbon fiber and PTFE.

Suitable conductivity modifiers include carbon fiber and boron nitride.

The feedstock material may further include a viscosity modifier such as ethylene-octene copolymer such as Paraloid 3815, buytyl acrylate/PMMA core-shell such as Paraloid 3361, silicone such as Kaneka Kane-Ace MR02, or polyoctohedralsilsesquioxane compounds.

Optionally, wherein the ratio of the copolymer shear viscosity measured at a shear rate of 100 s¹ to the copolymer shear viscosity measured at a shear rate of 10,000 s⁻¹ is from 2.0 to 6.0, with the shear viscosity at each shear rate measured using capillary rheometry operating at 400° C. using a circular cross-section tungsten carbide die, 0.5 mm (capillary diameter)×3.175 mm (capillary length), and more preferably, the ratio of the copolymer shear viscosity measured at a shear rate of 100 s⁻¹ to the copolymer shear viscosity measured at a shear rate of 10,000 s⁻¹ is from 3.0 to 5.5, or even more preferably, 3.5 to 5.0, with the shear viscosity at each shear rate measured using measured using capillary rheometry operating at 400° C. using a circular cross-section tungsten carbide die, 0.5 mm (capillary diameter)×8.0 mm (capillary length), where the shear rate is increased from 100 s⁻¹ to 10,000 s⁻¹.

Optionally, the annealing step is either carried out by either:

a) by passing the filament through an in-line oven, such that each part of the filament is in the oven for a period between 1 second and 5 minutes, wherein the temperature of the in-line oven is from 160° C. and 220° C.; or

b) by passing the filament through an in-line oven, such that the temperature of each part of the filament is raised to at least 160° C. and not more than 220° C. for at least 1 second; or

c) by placing a reel of up to 1500 m of wound filament in an oven, wherein the oven temperature is 160° C. to 190° C., and the reel of filament in left in the oven for at least 15 minutes to up to 24 hours.

More preferably, in step c) the reel comprises up to 1000 m of wound filament, or even more preferably, up to 500 m of wound filament.

In a further aspect, there is provided a filament according to the first aspect, wherein the filament has been processed by cutting to form short rods, pellets or powder. Short rods, pellets or powder are useful in certain deposition modelling apparatus and laser sintering processes.

One surprising benefit of the feedstock of the filament is that the filament is easier to print with because the annealing step controls the crystallinity of the filament and therefore, when in use, issues such as bulging and drooling during printing, often caused by differences in the filament diameter are overcome.

Said feedstock material may be used to define a composite material which could be prepared as described in Impregnation Techniques for Thermoplastic Matrix Composites. A Miller and A G Gibson, Polymer & Polymer Composites 4(7), 459-481 (1996), EP102158 and EP102159, the contents of which are incorporated herein by reference. Preferably, in the method, the copolymer and the filler means are mixed at an elevated temperature, suitably at a temperature at or above the melting temperature of the copolymer. Thus, suitably, the copolymer and filler means are mixed whilst the copolymer is molten. Said elevated temperature is suitably below the decomposition temperature of the copolymer. Said elevated temperature is preferably at or above the main peak of the melting endotherm (Tm) for copolymer. Said elevated temperature is preferably at least 300° C. Advantageously, the molten copolymer can readily wet the filler and/or penetrate consolidated fillers, such as fibrous mats or woven fabrics, so the composite material prepared comprises the composition and filler means which is substantially uniformly dispersed throughout the composition.

In one example, the filament may be used to form co-mingled yarns and tows. In another example, the filament may be formed into a unidirectional tape or towpreg. Other composites are also envisaged.

In alternative embodiments, the feedstock may be used in a unidirectional tape forming process to make a unidirectional tape comprising feedstock.

The feedstock material may be prepared in a substantially continuous process. In this case the copolymer and filler means may be constantly fed to a location wherein they are mixed and heated. An example of such a continuous process is extrusion. Another example (which may be particularly relevant wherein the filler means comprises a fibrous filler) involves causing a continuous filamentous mass to move through a shear or aqueous dispersion comprising said composition. The continuous filamentous mass may comprise a continuous length of fibrous filler or, more preferably, a plurality of continuous filaments which have been consolidated at least to some extent. The continuous fibrous mass may comprise a tow, roving, braid, woven fabric or unwoven fabric. The filaments which make up the fibrous mass may be arranged substantially uniformly or randomly within the mass. A composite material could be prepared as described in PCT/GB2003/001872, U.S. Pat. No. 6,372,294 or EP1215022.

Alternatively, the composite material may be prepared in a discontinuous process. In this case, a predetermined amount of copolymer and a predetermined amount of said filler means may be selected and contacted and a composite material prepared by causing the copolymer to shear and causing copolymer and filler means to mix to form a substantially uniform feedstock material.

Said filament may preferably have a diameter of at least 0.5 mm, more preferably at least 1 mm, even more preferably at least 1.5 mm, most preferably at least 1.7 mm; but preferably at most 5 mm, more preferably at most 3 mm, more preferably at most 2 mm, most preferably 1.9 mm.

The filament may have a cross-sectional diameter from 0.5 mm to 5 mm. More preferably, the filament may have a cross-sectional diameter from 1 mm to 3 mm. Even more preferably, the filament may have a cross-sectional diameter of 1.75 mm or 2 mm, or 2.5 mm, 2.85 mm or 3 mm. The most preferred cross-sectional diameter of the filament is 1.75 mm and another most preferred cross-sectional diameter of the filament is 2.85 mm.

In another embodiment, the copolymer may be used as the feedstock without any filler, to form a filament. The filament may be used in a fused filament fabrication process to improve z-direction strength of a printed component.

In a further aspect, there is provided a method for manufacturing a filament suitable for filament fusion printing, said method comprises:

a) selecting a feedstock comprising a polyaryletherketone, PAEK, and optionally one or more filler means, wherein the PAEK is a copolymer comprising repeat units of formula

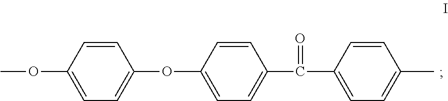

and

repeat units of formula

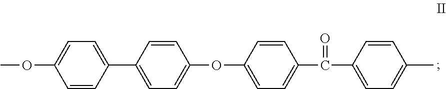

wherein at least 95 mol % of the copolymer repeat units are repeat units of formula I and of formula II;

wherein the repeat units I and II have a molar ratio 1:11 from 60:40 to 80:20; and

wherein the PAEK has a shear viscosity, SV, from 100 to 400 Pa·s as measured using capillary rheometry at operating at 400° C. at a shear rate of 1000 s⁻¹ using a circular cross-section tungsten carbide die, 0.5 mm (capillary diameter)×8 mm (capillary length);

b) extruding said feedstock through a die to form a filament; and

c) passing said filament through an oven, said oven having a temperature of at least 150° C.

Printed, printing, or print, refers to making components using an additive manufacturing process such as fused filament fabrication.

Specific embodiments of the invention will now be described by reference to the following Examples.

### EXAMPLE 1—PREPARATION OF 0.5 MOL POLYETHERETHERKETONE (PEEK)-POLYETHERDIPHENYLETHERKETONE (PEDEK) Copolymer

A 0.5 litre flanged flask fitted with a ground glass lid, stirrer/stirrer guide, nitrogen inlet and outlet was charged with 4,4′-difluorobenzophenone (111.06 g, 0.51 mol), 1,4-dihydroxybenzene (41.29 g, 0.375 mol), 4,4′-dihydroxydiphenyl (23.28 g, 0.125 mol) and diphenylsulphone (242.30 g) and purged with nitrogen for 1 hour. The contents were then heated under a nitrogen blanket to 160° C. to form an almost colourless solution. While maintaining a nitrogen blanket, dried sodium carbonate (53.40 g, 0.5 mol) and potassium carbonate (2.76 g, 0.02 mol), both sieved through a screen with a mesh size of 500 micrometres, were added. The temperature was raised to 185° C. at 1° C./min and held for 100 minutes. The temperature was raised to 205° C. at 1° C./min and held for 20 minutes. The temperature was raised to 305° C. at 1° C./min and held for approximately 60 minutes or until the desired SV was reached as indicated by the torque rise on the stirrer. The required torque rise was determined from a calibration graph of torque rise versus SV. The reaction mixture was then poured into a foil tray, allowed to cool, milled and washed with 2 litres of acetone and then with warm water at a temperature of 40-50° C. until the conductivity of the wastewater was <2 μS. The resulting PEEK-PEDEK powder was dried in an air oven for 12 hours at 120° C.

The resulting polymer had a Shear Viscosity (SV) of 250 Pa·s at a temperature of 400° C. and a shear rate of 1000 s⁻¹, as measured by capillary rheometry as described below.

### EXAMPLE 2—PREPARATION OF 0.5 MOL POLYETHERETHERKETONE (PEEK)-POLYETHERDIPHENYLETHERKETONE (PEDEK) COPOLYMER

A 0.5 litre flanged flask fitted with a ground glass lid, stirrer/stirrer guide, nitrogen inlet and outlet was charged with 4,4′-difluorobenzophenone (112.05 g, 0.51 mol), 1,4-dihydroxybenzene (35.79 g, 0.325 mol), 4,4′-dihydroxydiphenyl (32.59 g, 0.175 mol) and diphenylsulphone (246.50 g) and purged with nitrogen for 1 hour. The contents were then heated under a nitrogen blanket to 160° C. to form an almost colourless solution. While maintaining a nitrogen blanket, dried sodium carbonate (54.98 g, 0.5 mol) and potassium carbonate (0.17 g, 1.23×10⁻³ mol), both sieved through a screen with a mesh size of 500 micrometres, were added. The temperature was raised to 185° C. at 1° C./min and held for 100 minutes. The temperature was raised to 205° C. at 1° C./min and held for 20 minutes. The temperature was raised to 305° C. at 1° C./min and held for approximately 60 minutes or until the desired SV was reached as indicated by the torque rise on the stirrer. The required torque rise was determined from a calibration graph of torque rise versus SV. The reaction mixture was then poured into a foil tray, allowed to cool, milled and washed with 2 litres of acetone and then with warm water at a temperature of 40-50° C. until the conductivity of the wastewater was <2 μS. The resulting PEEK-PEDEK powder was dried in an air oven for 12 hours at 120° C.

The resulting polymer had a Shear Viscosity (SV) of 185 Pa·s at a temperature of 400° C. and a shear rate of 1000 s⁻¹, as measured by capillary rheometry as described below.

### EXAMPLE 3—PREPARATION OF 0.5 MOL POLYETHERETHERKETONE (PEEK)-POLYETHERDIPHENYLETHERKETONE (PEDEK) COPOLYMER

A 0.5 litre flanged flask fitted with a ground glass lid, stirrer/stirrer guide, nitrogen inlet and outlet was charged with 4,4′-difluorobenzophenone (112.05 g, 0.51 mol), 1,4-dihydroxybenzene (35.79 g, 0.325 mol), 4,4′-dihydroxydiphenyl (32.59 g, 0.175 mol) and diphenylsulphone (246.50 g) and purged with nitrogen for 1 hour. The contents were then heated under a nitrogen blanket to 160° C. to form an almost colourless solution. While maintaining a nitrogen blanket, dried sodium carbonate (54.98 g, 0.5 mol) and potassium carbonate (0.17 g, 1.23×10⁻³ mol), both sieved through a screen with a mesh size of 500 micrometres, were added. The temperature was raised to 185° C. at 1° C./min and held for 100 minutes. The temperature was raised to 205° C. at 1° C./min and held for 20 minutes. The temperature was raised to 305° C. at 1° C./min and held for approximately 60 minutes or until the desired SV was reached as indicated by the torque rise on the stirrer. The required torque rise was determined from a calibration graph of torque rise versus SV. The reaction mixture was then poured into a foil tray, allowed to cool, milled and washed with 2 litres of acetone and then with warm water at a temperature of 40-50° C. until the conductivity of the wastewater was <2 μS. The resulting PEEK-PEDEK powder was dried in an air oven for 12 hours at 120° C.

The resulting polymer had a Shear Viscosity (SV) of 239 Pa·s at a temperature of 400° C. and a shear rate of 1000 s⁻¹, as measured by capillary rheometry as described below.

### EXAMPLE 4—PREPARATION OF 0.5 MOL POLYETHERETHERKETONE (PEEK)-POLYETHERDIPHENYLETHERKETONE (PEDEK) COPOLYMER

A 0.5 litre flanged flask fitted with a ground glass lid, stirrer/stirrer guide, nitrogen inlet and outlet was charged with 4,4′-difluorobenzophenone (111.72 g, 0.51 mol), 1,4-dihydroxybenzene (41.29 g, 0.375 mol), 4,4′-dihydroxydiphenyl (23.28 g, 0.125 mol) and diphenylsulphone (313.00 g) and purged with nitrogen for 1 hour. The contents were then heated under a nitrogen blanket to 160° C. to form an almost colourless solution. While maintaining a nitrogen blanket, dried sodium carbonate (53.42 g, 0.5 mol) and potassium carbonate (2.76 g, 0.02 mol), both sieved through a screen with a mesh size of 500 micrometres, were added. The temperature was raised to 185° C. at 1° C./min and held for 100 minutes. The temperature was raised to 205° C. at 1° C./min and held for 20 minutes. The temperature was raised to 305° C. at 1° C./min and held for approximately 60 minutes or until the desired SV was reached as indicated by the torque rise on the stirrer. The required torque rise was determined from a calibration graph of torque rise versus SV. The reaction mixture was then poured into a foil tray.

After cooling to room temperature, the crude polymer in coarse powder form was then washed with acetone and then with warm water at a temperature of 40-50° C. until the conductivity of the wastewater was <2 μS. The resulting PEEK-PEDEK powder was dried in an air oven for 12 hours at 120° C.

The resulting polymer had a Shear Viscosity (SV) of 115 Pa·s at a temperature of 400° C. and a shear rate of 1000 s⁻¹, as measured by capillary rheometry as described below.

Example 4 is particularly well suited for certain fillers such as fibrous fillers having lengths between around 100 microns and 500 microns. The shear viscosity is tuned to enable a filler weight % of between 10 wt. % and 20 wt. %. The filler contributes to the overall viscosity of the feedstock and this is even more pronounced when using fibrous fillers.

### Comparative Examples

Filament Thermax PEKK-C was obtained from 3DXTECH, 904 36th Street, Suite B, Grand Rapids, Mich. 49508 USA. The SV of the polymeric material was 280 Pa·s at a temperature of 400° C. and a shear rate of 1000 s⁻¹, as measured by capillary rheometry as described below.

Filament formed from Victrex PEEK 450G was also used. The SV of 450G was 350 Pa·s.

Manufacture of Filament

Filament was formed from the following feedstock material: Victrex 450G and Examples 1, 2, 3, and 4. The selected feedstock was melted and extruded through a die with a 4 mm orifice. The extruder meter pump speed was used to control the final diameter of the filament. A filament having a diameter of 1.77 mm was formed. Once the filament was formed, the filament underwent an annealing step by placing the filament in an oven at room temperature and increasing the temperature of the oven at a rate of 10° C. per minute until the oven was at a temperature of 180° C. The filament was left in the oven for a period of three hours. The final filament had a crystallinity of at least 20%, but typically the crystallinity of the filament was 24%. Crystallinity was measured according to the method below.

Measurement of Crystallinity—Differential Scanning Calorimetry of the Copolymers of Examples 1 to 4

Crystallinity may be assessed by several methods for example by density, by IR spectroscopy, by X-ray diffraction or by differential scanning calorimetry (DSC).

The Glass Transition Temperature (Tg), the Melting Temperature (Tm) and Heat of Fusion of Melting (delta Hm) for the polymers from Examples 1 to 4 were determined using the following DSC method.

Crystallinity may be assessed by several methods for example by density, by it spectroscopy, by x ray diffraction or by differential scanning calorimetry (DSC). The DSC method has been used to evaluate the crystallinity that developed in the polymers from Examples 1-4 using a Mettler Toledo DSC1 Star system with FRS5 sensor.

The Glass Transition Temperature (Tg), the Cold Crystallisation Temperature (Tn), the Melting Temperature (Tm) and Heat of Fusions of Nucleation (ΔHn) and Melting (ΔHm) for the polymers from Examples 1 to 4 were determined using the following DSC method.

A dried sample of each polymer was compression moulded into an amorphous film, by heating 7 g of polymer in a mould at 400° C. under a pressure of 50 bar for 2 minutes, then quenching in cold water producing a film of dimensions 120×120 mm, with a thickness in the region of 0.20 mm. An 8 mg plus or minus 3 mg sample of each film was scanned by DSC as follows:

Step 1 Perform and record a preliminary thermal cycle by heating the sample from 30° C. to 400° C. at 20° C./min.

Step 2 Hold for 5 minutes.

Step 3 Cool at 20° C./min to 30° C. and hold for 5 mins.

Step 4 ΔHm. Re-heat from 30° C. to 400° C. at 20° C./min, recording the Tg, Tn, Tm, ΔHn and

From the DSC trace resulting from the scan in step 4, the onset of the Tg was obtained as the intersection of the lines drawn along the pre-transition baseline and a line drawn along the greatest slope obtained during the transition. The Tn was the temperature at which the main peak of the cold crystallisation exotherm reaches a maximum. The Tm was the temperature at which the main peak of the melting endotherm reach maximum.

The Heat of Fusion for melting (ΔHm) was obtained by connecting the two points at which the melting endotherm deviates from the relatively straight baseline. The integrated area under the endotherm as a function of time yields the enthalpy (mJ) of the melting transition: the mass normalised heat of fusion is calculated by dividing the enthalpy by the mass of the specimen (J/g). The level of crystallisation (%) is determined by dividing the Heat of Fusion of the specimen by the Heat of Fusion of a totally crystalline polymer, which for polyetheretherketone is 130 J/g.

Filaments comprising Examples 1 to 4, had a measured final crystallinity of 24%.

Measurement of Shear Viscosity

The shear viscosity, SV, was measured according to a Standard method as defined in ISO11443:2014 using capillary rheometry operating at 400° C. at a shear rate of 1000 s⁻¹ using a circular cross-section tungsten carbide die, 0.5 mm (capillary diameter)×8 mm (capillary length). The range of SV of the polymeric material selected was from around 100 Pa·s to around 400 Pa·s, at 400° C.

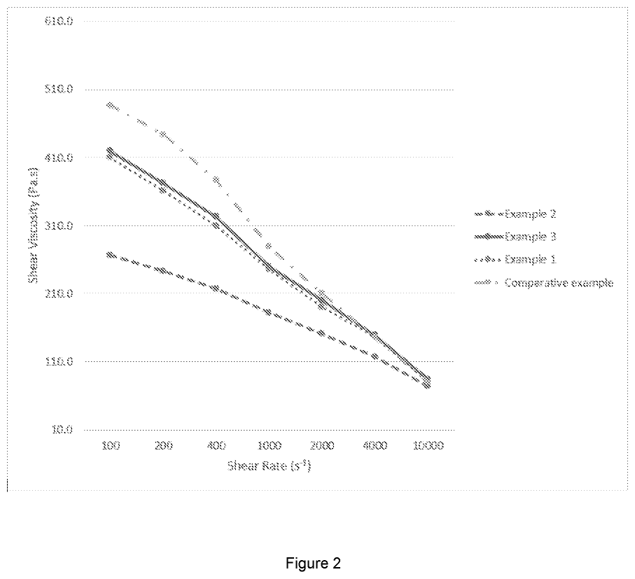

The results for the rheology shear rate sweeps are shown in FIG. 2. FIG. 2 includes shear rate sweeps for Examples 1, 2 and 3 and Comparative example Filament Thermax PEKK-C. The ratio of the copolymer shear viscosity measured at a shear rate of 100 s⁻¹ to the copolymer shear viscosity measured at a shear rate of 10,000 s⁻¹ is from 2.0 to 6.0, with the shear viscosity at each shear rate measured using capillary rheometry at 400° C. by extrusion through a tungsten carbide capillary die of 0.5 mm diameter and 8.0 mm length. The ratio for the comparative example is over 6.0. It has been surprisingly found that filaments made from feedstock made from copolymer having these rheological properties perform very well when printed and produce parts having superior z-strength.

Improving the low shear rheological properties of filament according to the invention improves certain mechanical and physical properties of components made from the filament in fused filament fabrication as it can aid interlayer adhesion.

When looking at the mechanical properties of polymer printing using filament fusion fabrication (FFF), it is useful to not only consider test specimens printed horizontally (X and Y directions), but also vertically (Z-direction). This is because Z-strength is a measure of interlayer adhesion, which is required to impart good mechanical strength in real components (as opposed to simple, quasi-2-dimensional test bars).

For example, test bars printed using the filament made with feedstock comprising the copolymer of Example 1 showed a Z-direction strength of 43 MPa, when printed in a filament fusion fabrication printer with no heated chamber.

A filament made using feedstock comprising the copolymer made according to Example 2 had a Z-direction of strength of 54 MPa.

By comparison, a component printed in the same manner but with a conventional PEEK polymer (Victrex 450G for example) has a Z-strength of around 16 MPa.

Filament according to the present invention provides upwards of almost three times the z-direction strength in a printed component compared to printed components printed with PEEK filaments.

It has been surprisingly found that components printed with filament according to the present invention comprising feedstock including fillers such as glass, mineral, carbon, or other inorganic fillers may improve mechanical properties above the Tg of the copolymer, including improving stiffness, strength, heat deflection properties, electrical properties such as conductivity or insulation properties, and creep resistance. Such materials are beneficial for use in seal rings and of sealing components, especially in relation to energy applications such as in oil and gas industries. Certain fillers such as glass filler may be used to provide stiffness for structural applications.

Filament according to the present invention, used to print components for aerospace applications, comprising fillers such as glass, mineral, carbon, or other inorganic fillers may improve mechanical properties above the Tg of the copolymer, including improving stiffness, strength, and creep resistance. Such materials are beneficial for use in system attachments, including but not limited to wire clamps, brackets, straps and other components, especially in relation to aerospace components and parts of aircraft.

Filament according to the present invention, used to print components for automotive applications, comprising fillers such as glass, mineral, carbon, or other inorganic fillers may improve mechanical properties above the Tg of the copolymer, including improving stiffness, strength, and creep resistance. Such materials are beneficial for use in under-hood engine compartment brackets, cable clamps, and other elevated temperature applications in vehicles.

Components such as gears, bearings and transmission components made with filament comprising PTFE, carbon fibre and other fillers that minimise friction, wear, and tribological performance of components.

Components such as bio-reactors and static mixers may be manufactured with filament comprising fillers having catalytic properties, or that improve the adhesion of coatings added to the printed component that impart such properties.

Electro-static discharge (ESD) performance has been found to be imparted by selecting conductive fillers including short and long carbon fibre, carbon black, and other electrically conductive additives. The benefit of such fillers in filament according to the invention is that components may be printed to support protection from lightning strike and enable grounding to protect sensitive electronics and controls.

Filament according to the present invention may be used to manufacture medical components such as implants adapted for improved osseointegration using hydroxyapatite.

In certain examples filament according to the present invention may be overprinting applications whereby filament according to the invention is used to print fine detail onto a moulded part, such as a polyetheretherketone part of a copolymer part where the copolymer is the same copolymer described in the first aspect of the invention. Alternatively, the printed component may form an insert in a moulded component where the over-moulding material has a higher shearing temperature than the copolymer according to the first aspect of the invention.

In other examples, components such as manifolds and heat exchangers are made with filament according to the present invention. Fillers are selected to improve thermal conductivity to improve the thermal heat exchange, and/or rapid heating/cooling of fluids in manifolds and heat exchangers.

Fillers such as talc may be used to reduce CTE and post printing shrinkage to enable larger part printing. Other inorganic fillers such as glass and carbon fibre and particles may be used to similarly reduce thermal expansion, including shrink and warp that may occur during the printing process. Filament with fillers such as talc are useful for printed antenna substrates and three-dimensional electronic components.

Other additive manufacturing processes exist and the feedstock and filament described above are usable in other such processes. Those other processes include but are not limited to extrusion-based processes, powder bed fusion (PBF) processes and three-dimensional composites additive manufacturing processes.

As such, the feedstock comprising copolymer and filler means described herein may also be applied to other manufacturing processes to impart similar performance benefits in the manufactured components. For example, the feedstock may be used in other form factors (shapes) used as inputs to other melt extrusion additive manufacturing processes, such as thick rods, moulded preform shapes, powders, or granules as inputs to direct extrusion additive manufacturing machines. By extension, the feedstock material described herein may also be used powder based additive manufacturing processes such as selective laser sintering and binder jet high speed sintering processes, wherein the feedstock material is milled into powders suitable for such processes. Beyond additive manufacturing, the feedstock material described herein, when applied to granules, pellets, or powders may also be applied to melt based manufacturing process such as injection moulding, extrusion, or compression moulding.

The described and illustrated embodiments are to be considered as illustrative and not restrictive in character, it being understood that preferred embodiments have been shown and described and that all changes and modifications that come within the scope of the inventions as defined in the claims are desired to be protected. It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “at least one portion” are used to preface a feature there is no intention to limit the claim to only one such feature unless specifically stated to the contrary in the claim.

1. A fused filament fabrication (FFF) filament, for use in layer-wise formation of a component, wherein the filament comprises feedstock material comprising a polyaryletherketone, PAEK and one or more filler means, wherein the PAEK is a copolymer comprising repeat units of formula 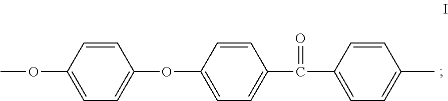
and
repeat units of formula 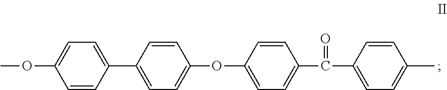
wherein at least 95 mol % of the copolymer repeat units are repeat units of formula I and of formula II;
wherein the repeat units I and II have a molar ratio 1:11 from 60:40 to 80:20; and
wherein the PAEK has a shear viscosity, SV, from 100 to 400 Pa·s as measured using capillary rheometry at 400° C. at a shear rate of 1000 s⁻¹ by extrusion through a tungsten carbide capillary die of 0.5 mm diameter and 8.0 mm length; and
wherein the one of more fillers comprises at least 5 wt. % and up to 38 wt. % of the composition.

2. A filament according to claim 1 wherein the SV of the copolymer is from 150 to 300 Pa·s, and more preferably, 180 to 260 Pa·s.

3. A filament according to claim 1 or claim 2 wherein the molar ratio 1:11 of the copolymer is from 70:30 to 80:20.

4. A filament according to any preceding claim, wherein the one of more fillers is selected from a fibrous filler and a non-fibrous filler.

5. A filament according to any preceding claim, wherein the fibrous filler is a continuous fibrous filler or a discontinuous fibrous filler.

6. A filament according to any preceding claim, wherein the one or more fillers is selected from glass fibre, carbon fibre, asbestos fibre, silica fibre, alumina fibre, zirconia fibre, boron nitride fibre, silicon nitride fibre, boron fibre, fluorocarbon resin fibre and potassium titanate fibre, mica, silica, talc, HydroxyApatite (or Hydroxyl Apatite), alumina, kaolin, calcium sulfate, calcium carbonate, titanium oxide, titanium dioxide, zinc sulphide, ferrite, clay, glass powder, zinc oxide, nickel carbonate, iron oxide, quartz powder, magnesium carbonate, fluorocarbon resin, graphite, graphene, carbon powder, nanotubes, nanofibres and/or barium sulphate.

7. A filament according to any preceding claim, wherein the one or more fillers is discontinuous carbon fibre having a nominal length between 50 microns and 300 microns, and more preferably between 100 and 300 micros and even more preferably between 125 microns and 175 microns.

8. A filament according to any preceding claim, wherein the feedstock material further includes a viscosity modifier selected from ethylene-octene copolymer such as Paraloid 3815, buytyl acrylate/PMMA core-shell such as Paraloid 3361, silicone such as Kaneka Kane-Ace MR02, or polyoctohedralsilsesquioxane compounds.

9. A filament according to any preceding claim, wherein the ratio of the copolymer shear viscosity measured at a shear rate of 100 s⁻¹ to the copolymer shear viscosity measured at a shear rate of 10,000 s⁻¹ is from 2.0 to 6.0, with the shear viscosity at each shear rate measured using capillary rheometry at 400° C. by extrusion through a tungsten carbide capillary die of 0.5 mm diameter and 8.0 mm length, and more preferably, the ratio of the copolymer shear viscosity measured at a shear rate of 100 s⁻¹ to the copolymer shear viscosity measured at a shear rate of 10,000 s⁻¹ is from 3.0 to 5.5, or even more preferably, 3.5 to 5.0, with the shear viscosity at each shear rate measured using capillary rheometry at 400° C. by extrusion through a tungsten carbide capillary die of 0.5 mm diameter and 8.0 mm length.

10. The use of a filament according to any preceding claim, in a process for formation of a component in a layer-wise fashion by sequentially depositing layers of the feedstock material in layers, each layer defining a cross-section of the component.

11. A method for manufacturing a component, the method comprising:
(i) selecting a filament, according to claim 1; and
(ii) forming the component in a layer-wise fashion by feeding the filament through an extruder nozzle and sequentially depositing layers of feedstock material such that a plurality of layers correspond to respective cross-sections of the component;
wherein a first layer of feedstock material forms a base layer of the component; and
each subsequently deposited layer of feedstock material forms a subsequent layer of the component and bonds to the respective preceding layer of the component on contact with the preceding layer whereby the component is formed from the mutually bonded portions of the plurality of layers corresponding to respective cross-sections of the component.

12. A process for improving the printability of a fused filament fabrication filament, the process comprising:
extruding feedstock material through a die to form a filament wherein the feedstock material comprises a polyaryletherketone, PAEK and optionally, one or more filler means;
annealing the filament at a temperature between a glass transition temperature Tg of the feedstock material and a melt temperature Tm of the feedstock material, for a period of time sufficient to increase the temperature of the filament to above the glass transition temperature of the feedstock material.

13. A process according to claim 12, wherein the feedstock material comprises:
a copolymer comprising repeat units of formula 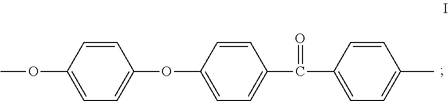
and
repeat units of formula 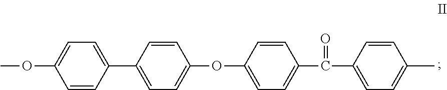
wherein at least 95 mol % of the copolymer repeat units are repeat units of formula I and of formula II;
wherein the repeat units I and II have a molar ratio 1:11 from 60:40 to 80:20; and
wherein the PAEK has a shear viscosity, SV, from 100 to 400 Pa·s as measured using capillary rheometry at 400° C. at a shear rate of 1000 s⁻¹ by extrusion through a tungsten carbide capillary die of 0.5 mm diameter and 8.0 mm length; and
wherein the one of more fillers comprises at least 5 wt. % and up to 38 wt. % of the composition.

14. A process according to claim 12 or 13, wherein the annealing step is either carried out by either:
a) by passing the filament through an in-line oven, such that each part of the filament is in the oven for a period between 1 second and 5 minutes, wherein the temperature of the in-line oven is from 160° C. and 220° C.; or
b) by passing the filament through an in-line oven, such that the temperature of each part of the filament is raised to at least 160° C. and not more than 220° C. for at least 1 second; or
c) by placing a reel of up to 1500 m of wound filament in an oven, wherein the oven temperature is 160° C. to 190° C., and the reel of filament in left in the oven for at least 15 minutes to up to 24 hours.

15. A process according to claim 14, wherein the temperature of the oven in c) is set at 180° C., and is heated to 180° C. from room temperature at a heating rate of 10° C. per minute, and the reel is placed in the oven when the oven is at room temperature.
